(19) United States
(12) Patent Application Publication
(10) Pub. No.: US 2025/0293975 A1
(43) Pub. Date: Sep. 18, 2025

(54) OPTIMIZATION OF NETWORK ROUTING FOR APPLICATION PERFORMANCE

(71) Applicant: T-MOBILE INNOVATIONS LLC, Overland Park, KS (US)

(72) Inventors: Antoine TRAN, Bellevue, WA (US); Jeffery Aaron SMITH, Bothell, WA (US); Emile TRAN, Sammamish, WA (US)

(21) Appl. No.: 18/603,903

(22) Filed: Mar. 13, 2024

(51) Int. Cl. H04L 45/00

(52) U.S. Cl. CPC H04L 45/70; H04L 45/306; H04L 47/2475

(57) ABSTRACT

Aspects herein provide systems, methods, and media for optimizing network routing configuration for specific applications. In aspects, the data traffic of an application can be intelligently and selectively routed using specific network “slices” or “paths” that optimize the application's performance for a metric, such as jitter or latency. As such, various network routing configurations can be monitored and evaluated to examine the application's performance over particular network slices, and further optimize configurations for specific data traffic types and volumes, particular devices, and more.

### TECHNICAL BACKGOUND

The present disclosure generally relates to optimizing network routing for improved software application performance on a device.

### SUMMARY

A high-level overview of various aspects of the disclosure is provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

In one aspect, a computerized method is provided. A plurality of network routing configurations that are available to a user device for an application are received. From the plurality of network routing configurations that are available to the user device, a first set of routing configurations is generated that is at least partially randomized, in aspects. Performance of the application is monitored when using the first set of routing configurations that is at least partially randomized at the user device, in aspects. Performance of the application is evaluated for each network routing configuration in the first set of routing configurations, in various aspects. In aspects, a first preferred network routing configuration is selected for the application that has an improved performance metric relative to a remaining network routing configuration in the first set of routing configurations evaluated.

In another aspect, one or more non-transitory computer-readable media are provided for storing instructions that when executed via one or more processors perform a computerized method. A plurality of network routing configurations that are available to a user device for an application are received. From the plurality of network routing configurations that are available to the user device, a first set of routing configurations is generated that is at least partially randomized, in aspects. According to the instructions, performance of the application is monitored when using the first set of routing configurations that is at least partially randomized at the user device, in aspects. Performance of the application is evaluated for each network routing configuration in the first set of routing configurations, in various aspects. In aspects, a first preferred network routing configuration is selected for the application that has an improved performance metric relative to a remaining network routing configuration in the first set of routing configurations evaluated.

In yet another aspect, a system is provided. The system includes a computer application that, via one or more processors, execute computer-readable instructions stored in memory of a device. Via the instructions, a plurality of network routing configurations are available to a user device for an application. From the plurality of network routing configurations that are available to the user device, a first set of routing configurations is generated that is at least partially randomized. Performance of the application is monitored when using the first set of routing configurations that is at least partially randomized at the user device, in aspects. Performance of the application is evaluated for each network routing configuration in the first set of routing configurations, in various aspects. In aspects, a first preferred network routing configuration is selected for the application that has an improved performance metric relative to a remaining network routing configuration in the first set of routing configurations evaluated.

### BRIEF DESCRIPTION OF THE DRAWINGS

Aspects are described in detail below with reference to the attached drawings figures, wherein:

FIG. 1 depicts an example of a system environment, in accordance with one or more aspects;

FIG. 2 depicts a diagram showing example interactions between various components of the system of FIG. 1, in accordance with one or more aspects;

FIG. 3 depicts a flowchart of an example method, in accordance with one or more aspects;

FIG. 4 depicts a simplified diagram of an example device suitable for use in implementations of the disclosure.

### DETAILED DESCRIPTION

The subject matter of the present disclosure is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present disclosure can be embodied in many different forms and should not be construed as limited to the embodiments and aspects set forth herein.

Throughout this disclosure, several acronyms and shorthand notations are used to aid the understanding of certain concepts pertaining to the associated system and services. These acronyms and shorthand notations are intended to help provide an easy methodology of communicating the ideas expressed herein and are not meant to limit the scope of the present disclosure. The following is a list of these acronyms:

| | |
|---|---|
| 3G | Third-Generation Wireless Access Technology |
| 4G | Fourth-Generation Wireless Access Technology |
| 5G/5G NR | Fifth-Generation Wireless Access |
| | Technology/ New Radio |
| 5GC | Fifth-Generation Wireless Access |
| | Technology Core Network |
| AAU | Active Antenna Unit |
| BRS | Broadband Radio Service |
| CD-ROM | Compact Disk Read-Only Memory |
| CDMA | Code Division Multiple Access |
| CU | Central Unit |
| DU | Distribution Unit |
| EIRP | Equivalent Isotropically Radiated Power |
| eNodeB | Evolved Node B |
| EVDO | Evolution-Data Optimized |
| GIS | Geographic/Geographical/Geospatial Information |
| | System |
| gNodeB/gNB | Next Generation Node B |
| gNB CU | Next Generation Node B Central Unit |
| gNB DU | Next Generation Node B Distribution Unit |
| GPRS | General Packet Radio Service |
| GSM | Global System for Mobile Communication |
| IDEN | Integrated Digital Enhanced Network |
| DVD | Digital Versatile Disc |
| EEPROM | Electrically Erasable Programmable |
| | Read-Only Memory |
| FD-MIMO | Full Dimension Multiple-Input Multiple-Output |
| IOT | Internet of Things |
| IIOT | Industry Internet of Things |
| IP | Internet Protocol |
| LED | Light Emitting Diode |
| LTE | Long Term Evolution |
| MEC | Mobile Far Edge Computer |
| MD | Mobile Device |
| MIMO | Multiple-Input Multiple-Output |
| mMIMO | Massive Multiple-Input Multiple-Output |
| MMU | Massive Multiple-Input Multiple-Output Unit |
| mm Wave | Millimeter Wave |
| NEXRAD | Next-Generation Radar |
| NR | New Radio |
| OOBE | Out-of-Band-Emission |
| OTN | Optical Transport Network |
| PC | Personal Computer |
| PCS | Personal Communications Service |
| PDA | Personal Digital Assistant |
| PLMN | Public Land Mobile Network |
| PRB | Physical Resource Block |
| vPRB | Virtualized Physical Resource Block |
| RAN | Radio Access Network |
| RAM | Random Access Memory |
| RET | Remote Electrical Tilt |
| RF | Radio-Frequency |
| RFI | Radio-Frequency Interference |
| RIC | Radio Intelligent Controller |
| RLF | Radio Link Failure |
| R/N | Relay Node |
| RNR | Reverse Noise Rise |
| ROM | Read-Only Memory |
| RRU | Remote Radio Unit |
| RSRP | Reference Signal Receive Power |
| RSRQ | Reference Signal Receive Quality |
| RSSI | Received Signal Strength Indicator |
| RU | Radio Unit |
| SINR | Signal-to-Interference-&-Noise Ratio |
| SNR | Signal-to-Noise Ratio |
| SON | Self-Organizing Networks |
| TDMA | Time Division Multiple Access |
| TXRU | Transceiver (or Transceiver Unit) |
| UE | User Equipment |
| UMTS | Universal Mobile Telecommunications System |
| UTRAN | UMTS Radio Access Network |
| E-UTRAN | Evolved Universal Mobile |
| | Telecommunications System |
| WCD | Wireless Communication Device |
| | (interchangeable with UE) |
| WLAN | Wireless Local Area Network |
| XR | Extended Reality |

Further, various technical terms are used throughout this description. An illustrative resource that fleshes out various aspects of these terms can be found in Newton's Telecom Dictionary, 25th Edition (2009).

Aspects herein may be embodied as, among other things: a method, system, or set of instructions embodied on one or more computer-readable media. Aspects may take the form of a hardware aspect or an aspect combining software and hardware. Some aspects may take the form of a computer program product that includes computer-useable or computer-executable instructions embodied on one or more computer-readable media.

### Definitions

“Computer-readable media” can be any available media and may include volatile and non-volatile media, as well as removable and non-removable media. By way of example, and not limitation, computer-readable media may include computer storage media and communication media. Computer-readable media may include both volatile and non-volatile media, removable and non-removable media, and may include media readable by a database, a switch, and various other network devices. Computer-readable media includes media implemented in any way for storing information. Examples of stored information include computer-useable instructions, data structures, program modules, and other data representations.

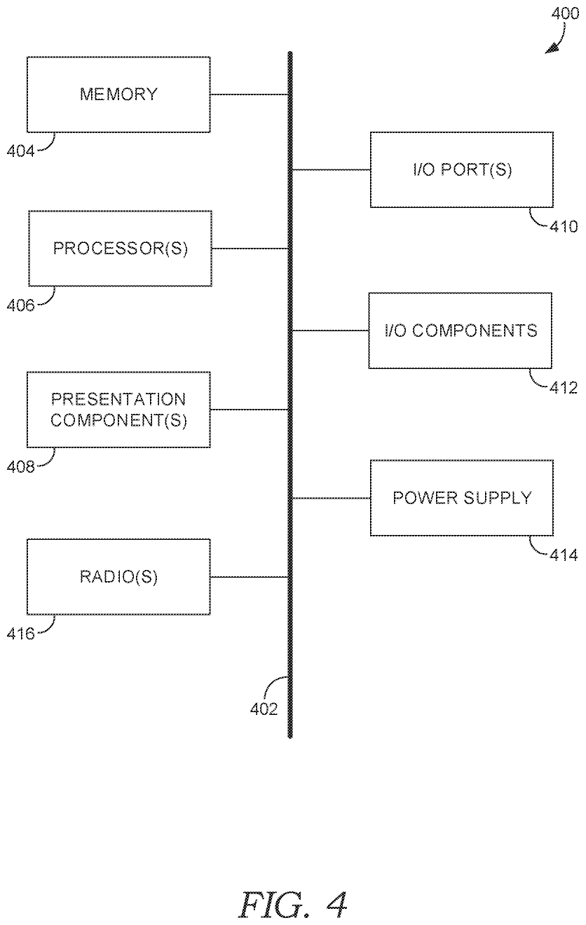

“Computer storage media” may include, without limitation, volatile and non-volatile media, as well as removable and non-removable media, implemented in any method or technology for the storage of information, such as computer-readable instructions, data structures, program modules, or other data. In this regard, computer storage media may include, but is not limited to, RAM, ROM, Electrically Erasable Programmable Read-Only Memory (EEPROM), flash memory or other memory technology, CD-ROM, DVD, holographic media, other optical disk storage, magnetic cassettes, magnetic tape, magnetic disk storage or other magnetic storage device, or any other medium that can be used to store the desired information and which may be accessed by the device 400 shown in FIG. 4. These technologies can store data momentarily, temporarily, or permanently.

“Communication media” may include, without limitation, computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner so as to encode information in the signal. By way of example, and not limitation, communication media includes wired media such as a wired network or direct-wired connection, and wireless media such as acoustic, radio frequency (RF), infrared, and other wireless media. Combinations of any of the above may also be included within the scope of computer-readable media.

The term “application” refers to software, a computer program, and/or an application programming interface that may be run by executing, by a processor, computer-readable instructions stored on memory for running the software. Examples of applications include social media applications, word processing applications, gaming application, messaging applications, video-streaming applications, and more, for example, as run on user devices.

“Engine” refers to a hardware- and software-based computer program that can be trained and deployed, is able to automatically learn (e.g., supervised, semi-supervised, unsupervised, and/or reinforcing) from data to identify patterns, and to make predictions with little to no human intervention. Generally, an engine involves, comprises, includes, and/or leverages machine-learning technology such as artificial intelligence in order to learn from data to identify patterns and make predictions. Accordingly, such engines may utilized models, control rules, patterns, and inputs to make predictions and/or inferences.

“Network” refers to a network comprised of wireless and wired components that provide wireless communications service coverage, for example, to one or more user devices. For example, the network may include one or more, or a plurality of, wireless networks, hardwired networks, telecommunications networks, peer-to-peer networks, distributed networks, and/or any combination thereof. The network may comprise one or more access points, one or more cell sites (i.e., managed by an access point), one or more structures such as cell towers (i.e., having an antenna) associated with each access point and/or cell site, a gateway, a backhaul data center, a server that connects two or more access points, a database, a power supply, sensors, and other components not discussed herein, in various aspects. Examples of a network include a telecommunications network (e.g., 3G, 4G, 5G, CDMA, CDMA 1XA, GPRS, EVDO, TDMA, GSM, LTE, and/or LTE Advanced) and/or a satellite network (e.g., Low Earth Orbit [LEO], Medium Earth Orbit [MEO], or geostationary). Additional examples of a network include a wide area network (WAN), a local area network (LAN), a metropolitan area network (MAN), a wide area local network (WLAN), a personal area network (PAN), a campus-wide network (CAN), a storage area network (SAN), a virtual private network (VPN), an enterprise private network (EPN), a home area network (HAN), a Wi-Fi network, a Worldwide Interoperability for Microwave Access (WiMAX) network, and/or an ad hoc (mesh) network. The network may include or may communicate with a physical location component for determining a geographic location of an item, package, parcel, personnel, vehicle, end-point location, etc., by leveraging, for example, a Global Positioning System (GPS), Global'naya Navigatsionnaya Sputnikovaya Sistema (GLONASS), BeiDou Navigation Satellite System (BDS), Global Navigation Satellite System (GNSS or “Galileo”), an indoor position system (IPS), or other positioning systems that leverage non-GPS signals or networks (e.g., signals of opportunity [SOP]).

The term “network routing configuration” refers to a parameter, rule, and/or a “setting” that governs how data packages are transferred to various network slices. Data packets are communicated using defined slices, also referred to interchangeably herein as routes, data pipes, paths, and/or flows, such that the data packet travels from one source through a network for delivery to a targeted destination. The network routing configurations define the slice or path that a data packet is to travel through the network (e.g., a sequence of physical data centers, servers, base stations, backhaul, etc.), from a source to a destination. Data packets can travel wirelessly and in a hardwired manner from one computing device to another computing device halfway across the Earth, for example, using the network slice and network components. In some aspects, network routing configurations can describe one or more parameters or settings that define or describe the slice or path using tuples. For example, a 3-tuple may specify one or more parameters or settings for a slice or path such as a source IP address or a destination IP address, and may identify a type of IP protocol (e.g., User Datagram Protocol [UDf1P], Transmission Control Protocol [TCP], and Real-time Transport Protocol [RTP]). In an example, a 5-tuple may specify one or more parameters or settings for a slice or path such as a source IP address or a destination IP address, and may identify a type of IP protocol, a source port, and a destination port. In various aspects, any n-tuple (n=integer) may be used.

“Access point” and “base station” are used interchangeably herein to reference hardware, software, devices, or other components for a communications device or structure having an antenna, an antenna array, a radio, a transceiver, and/or a controller. An access point can be deployed terrestrially at or near the Earth's surface, or within the atmosphere, for example, to orbit the Earth. For example, an “aerospace access point” may be a satellite deployed to orbit the Earth within or above the atmosphere (e.g., in the thermosphere or exosphere), whereas a “terrestrial access point” may be a fixed or semi-fixed base station located on the Earth's surface or upon any structure located on the surface. As discussed herein, an access point is a device comprised of hardware and complex software that is deployed in a network so that the access point can control and facilitate, via one or more antennas or antenna arrays, the broadcast, transmission, synchronization, and receipt of wireless signals in order to communicate with, verify, authenticate, and provide wireless communications service coverage to one or more user devices that request to join and/or are connected to the network. Generally, an access point can communicate directly with one or more user devices according to one or more access technologies (e.g., 3G, 4G, LTE, 5G, and mMIMO). An example of an aerospace access point includes a satellite. Examples of a terrestrial access point include a base station, an eNodeB, a gNodeB, a macrocell, a small cell, a microcell, a femtocell, a picocell, and/or a computing device capable of acting as a wireless “hotspot” that enables connectivity to the network. Accordingly, the scale and coverage area of various types of access points are not limited to the examples discussed. Access points may work alone or in concert with one another, locally or remotely.

“Cell site” is generally used herein to refer to a defined wireless communications coverage area (i.e., a geographic area) serviced by an access point or a plurality of neighboring access points working together to provide a single coverage area. Also, it will be understood that one access point may control one cell site/coverage area, or, alternatively, one access point may control multiple cell sites/coverage areas.

“User equipment” (UE), “user device,” “mobile device,” and “wireless communication device” are used interchangeably to refer to a device having hardware and software that is employed by a user in order to send and/or receive electronic signals/communication over one or more networks, whether terrestrial or aerospace. User devices generally include one or more antennas coupled to a radio for exchanging (e.g., transmitting and receiving) transmissions with an in-range base station that also has an antenna or antenna array. In aspects, user devices may constitute any variety of devices, such as a personal computer, a laptop computer, a tablet, a netbook, a mobile phone, a smartphone, a personal digital assistant, a wearable device, a fitness tracker, or any other device capable of communicating using one or more resources of the network. User devices may include components such as software and hardware, a processor, a memory, a display component, a power supply or power source, a speaker, a touch-input component, a keyboard, and the like. In various examples or scenarios that may be discussed herein, user devices may be capable of using 5G technologies with or without backward compatibility to prior access technologies, although the term is not limited so as to exclude legacy devices that are unable to utilize 5G technologies, for example.

The terms “radio,” “controller,” “antenna,” and “antenna array” are used interchangeably herein to refer to one or more software and hardware components that facilitate sending and receiving wireless radio frequency signals, for example, based on instructions from a base station. A radio may be used to initiate and generate information that is then sent out through the antenna array, for example, where the radio and antenna array may be connected by one or more physical paths. Generally, an antenna array comprises a plurality of individual antenna elements. The antennas discussed herein may be dipole antennas having a length, for example, of ¼, ½, 1, or 1½ wavelengths. The antennas may be monopole, loop, parabolic, traveling-wave, aperture, Yagi-Uda, conical spiral, helical, conical, radomes, horn, and/or apertures, or any combination thereof. The antennas may be capable of sending and receiving transmission via FD-MIMO, Massive MIMO, 3G, 4G, 5G, and/or 802.11 protocols and techniques.

Additionally, it will be understood that sequential or relative terms such as “first,” “second,” “third,” “primary,” and/or “secondary” are used herein for the purposes of clarity in distinguishing between elements or features, but the terms are not used herein to import, imply, or otherwise limit the relevance, importance, quantity, technological functions, physical or temporal sequence, physical or temporal order, and/or operations of any element or feature unless specifically and explicitly stated as such.

### Overview

Aspects herein provide systems, methods, and media for optimizing network routing configurations for specific applications. In aspects, the data traffic of an application can be intelligently and selectively routed using specific network “slices” or “paths” that optimize the application's performance. For example, the type of data traffic that the application generates by sending or receiving information over a network may be evaluated across different network configurations that define various network slices or paths. Accordingly, the performance of the application may be evaluated based on which network path is utilized, as each network path has different characteristics, data prioritization schema, or service quality. Specific types of data traffic may benefit from utilizing one particular network path over another network path, for example, based on one particular network path having a greater bandwidth than the other. By monitoring and learning about the data traffic of an application as routed over various network paths, aspects herein may evaluate the application's performance and intelligently select a network path that optimizes the applications' performance for its specific type of data traffic-thus matching the data resource usage of the application to an appropriately prioritized network path.

Aspects herein may concurrently, periodically, or simultaneously optimize network path routing for one or each of a plurality of applications, for example, on a user device. Each application may be individually monitored and evaluated such that intelligent, optimized network routing configurations may be selected for the application. Further, the optimized network routing configuration(s) that are selected may be shared with other devices and users, such that the other devices and users may implement the optimized network routing configuration(s). In this manner, the optimized network routing configuration(s) that are selected may be pooled, aggregated, and distributed in a crowd-sourced manner.

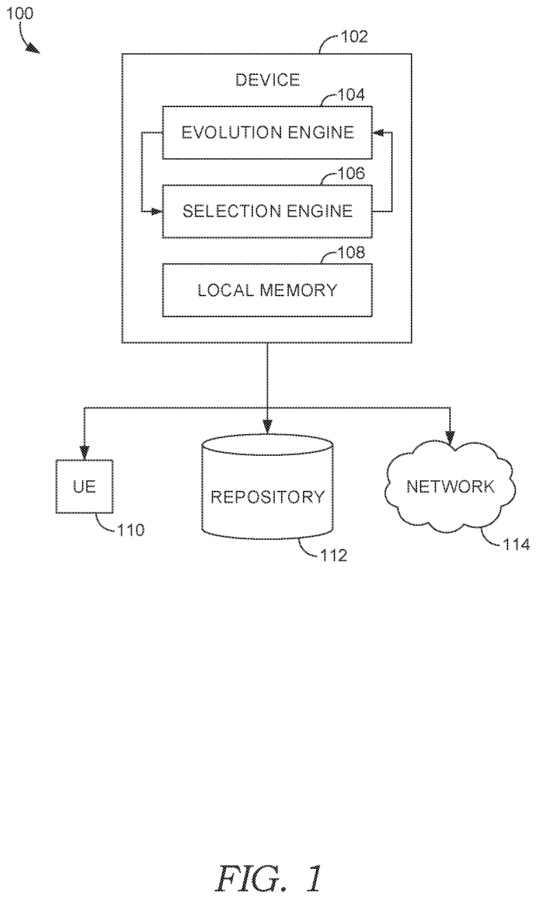

FIG. 1 depicts an example of a system environment 100. A device 102 operates within the system environment 100, in aspects. The device 102 may comprise one or more processors and local memory 108 that stores computer-readable instructions for execution. The device 102 may, via the one or more processors executing the computer-instructions, run one or more applications, connect to one or more services, and/or perform one or more various functionalities. In various aspects, the device 102 may be a user device, such as a router, a smartphone, a tablet, or the like. The device 102 may, additionally, represent a plurality of devices, such as a combination of a smartphone and a router, for example, or a router and a gaming console.

In an aspect, the device 102 may run an application or application programming interface (API) that determines, manages, and/or controls application-specific routing and switching across various network slices for optimized performance of one or more other “target” applications running (at least partially) on the device 102. The terms “application” and “API” are used interchangeably herein for simplicity. The slice-optimizing environment may include, utilize, control, and/or leverage an evolution engine 104 and a selection engine 106 in aspects, which may incorporate and/or otherwise rely on machine-learning models and techniques. The output from the slice-optimizing environment may be, in various aspects, communicated to one or more of a user device 110, a repository 112 (e.g., a server, a data store, or external memory, whether physical, virtual, distributed, or any combination thereof), and/or a network 114.

The evolution engine 104 may generate and monitor the performance of sets of network routing configurations, as further discussed herein. The selection engine 106 may ingest and/or receive information and/or data from the evolution engine 104 as input in order to select the best performing network routing configurations for the particular application. Accordingly, the selection engine 106 provides information and/or data to the evolution engine 104 as a feedback loop that may be performed once or a plurality of times, whether on demand, intermittently, or on a fixed or dynamic periodicity, as further discussed herein. As such, one or more optimized network routing configurations can be selected for a particular application and shared with other devices, networks, and/or users of the particular application.

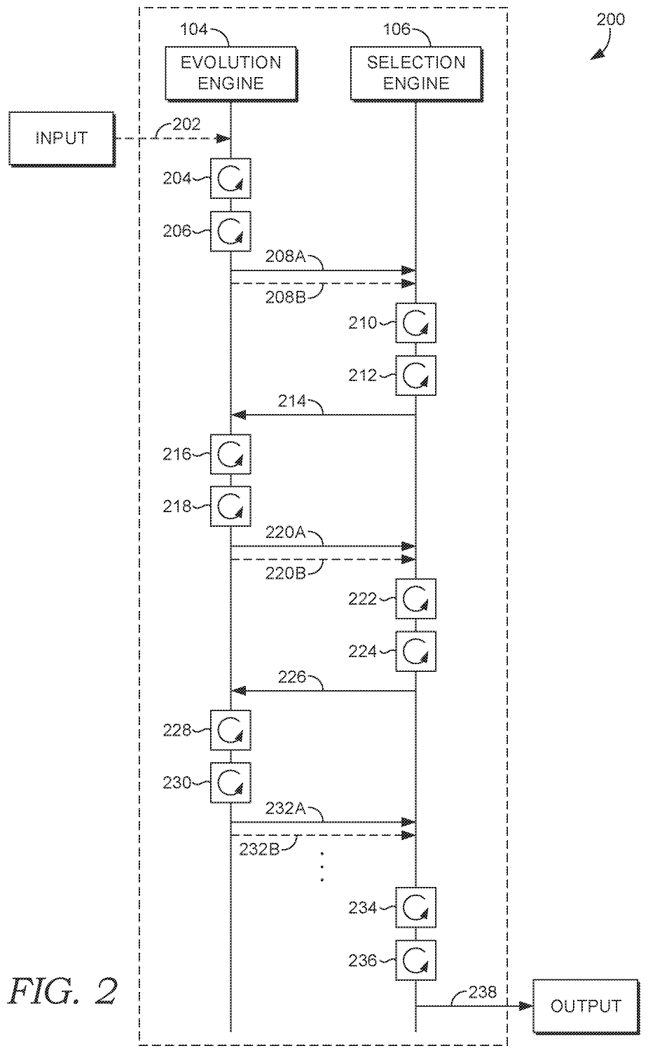

FIG. 2 depicts a diagram 200 showing example interactions between various components of the system of FIG. 1. For example, input 202 is communicated to the evolution engine 104 of the slice-optimizing environment of the device 102. The input may be a plurality of network routing configurations that are available to the device 102 for a target application, for example. In some aspects, the plurality of network routing configurations that are available to the user device for the application include a 3-tuple or a 5-tuple. For example, a 3-tuple may specify a source Internet Protocol (IP), a destination IP, an IP protocol, and/or any combination thereof. Additionally or alternatively, a 5-tuple may specify a source IP, a destination IP, an IP protocol, a source port, a destination port, and/or any combination thereof. Examples of an IP protocol may include internet protocols (IPv6, IPv4), legacy protocols, modern protocols, HTTP-based protocols, signaling protocols, and the like. Further examples of protocols include: UTP, TCP, and RTP, HTTP Live Streaming (HLS), Real-Time Messaging Protocol (RTMP), Real-Time Streaming Protocol (RTSP), Secure Reliable Transport (SRT), Transmission Control Protocol (TCP), Web Real-time Communication (WebRTC), and more. In one example, the plurality of network routing configuration includes a 3-tuple that specifies each of a source IP, a destination IP, and an IP protocol: (a449:a8c5:62a2:1de4:7329:5e6b:1f96:066c, ef4d:ec10:b968:d1c8:491e:50b0:6836:7196, IPv6).

In another example, the plurality of network routing configuration includes a 5-tuple that specifies each of a source IP, a destination IP, an IP protocol, a source port, and a destination port.

Utilizing the input, the evolution engine 104 generates 204 a first set of routing configurations that is at least partially randomized. For example, in response to receipt of the plurality of network routing configurations, the evolution engine 104 may automatically generate the first set of routing configurations which are based on and/or from the plurality of network routing configurations received. In one aspect, the first set of routing configurations may include multiple and different combinations of source IPs, destination IPs, IP protocols, source ports, and/or destination ports.

The evolution engine 104 monitors 206 how the target application performs by measuring one or more performance metrics when the target application is run via the device 102 using the first set of routing configurations that is at least partially randomized. The target application may be run using each of the routing configurations and/or combinations thereof. For example, each combination of the multiple, different combinations of source IPs, destination IPs, IP protocols, source ports, and/or destination ports in the first set of configurations can be monitored, such that one or more of latency, jitter, bandwidth, and/or any combination of performance metrics can be captured and measured for comparison to each other across the configuration.

The target application is monitored either during actual use by the device 102, or when run through emulation via the slice-optimizing environment, in various aspects, in order to capture and measure one or more performance metrics. Accordingly, the target application's communications, operations, functions, connectivity, and data may be observed, recorded, measured, and/or otherwise monitored by the evolution engine 104, relative to each distinct network routing configuration, and the network slice it refers to. The evolution engine 104 may also utilize information about the target application when monitoring the target application's data traffic. For example, when available, the first set of routing configurations may include information about the target application such as an application name, a unique application identifier, a source IP address, a source port identifier, a destination IP address, a destination port, a specific messaging or data configuration utilized to communicate with an external service or any combination thereof.

In some aspects, the device 102 and the evolution engine 104 may identify the target application based on one or more traffic characteristics monitored. The target application may be identified, sorted, and/or classified by the slice-optimizing environment as a category, type, or class of application based on the particular characteristics and/or other information collected and recognized via monitoring. Examples of characteristics of the target application include one or more of a protocol type (e.g., IP types such as Micro Transport Protocol [UTP], Transmission Control Protocol [TCP], and Real-time Transport Protocol [RTP]), a port identifier, an inter-packet arrival time, a packet size, a throughput value, and/or any combination thereof. The evolution engine 104 may, in one example, identify the type of target application based on a combination of inter-packet arrive time, packet size(s), and throughput. Inter-packet arrival times may vary between different types of target applications, generally. For example, the inter-packet arrival times and packet size(s) of a video-calling application may be different and distinguishable from the inter-packet arrival times and packet size(s) a cloud-based gaming application, a voice-chat application, and/or a video-chat application, such that the evolution engine 104 can differentiate and learn about a target application via the monitoring described herein. In some aspects, the slice-optimizing environment may select one or more particular performance characteristics to utilize as being specific indicator(s) for measuring performance of the target application, either in general or as specific to operating upon the device 102. For example, latency may be a prioritized performance metric to monitor in a target application involving gaming. In another example, jitter may be a prioritized metric to monitor in a target application involving voice calling.

Additionally, the evolution engine 104 may intelligently monitor only a portion of ports that are associated with application usage. For example, ports 0 through 1024 generally correspond to system functions, such that the evolution engine 104 may not monitor these ports, but instead may monitor ports with designations over 1024, where data traffic is involved.

The evolution engine 104 communicates 208A performance of the target application when using the first set of routing configurations that is at least partially randomized at the user device. The monitored measurements and/or results regarding one or more performance metrics of the target application's performance when utilizing the first set of routing configurations at the device 102 may be communicated as a batch, as a data stream, intermittently, periodically, on demand or a trigger, or any combination thereof, in various aspects. As such, the evolution engine 104 optionally communicates 208B performance of the target application in more than one instance. For example, the evolution engine 104 may monitor and communicate performance of the target application in an ongoing manner as the target application runs (or is emulated). In one example, the evolution engine 104 may monitor and communicate performance of the target application for each instance that the target application is run (or is emulated), so as to monitor and re-monitor performance of the target application at different instances using the same first set of routing configurations. In another example, the evolution engine 104 may monitor and communicate performance of the target application for each instance that the target application is run (or is emulated), so as to monitor and re-monitor performance of the target application at different instances using variation(s) of the first set of routing configurations.

Based on the performance reported by the evolution engine 104, the selection engine 106 evaluates 210 the performance of the target application for each network routing configuration in the first set of routing configurations. For example, the performance reported from the evolution engine 104 includes performance metric measurements for various characteristics, parameters, settings, and/or additional data, which the selection engine 106 utilized in order to evaluate, rate, compare, and/or otherwise determine the quality (or lack thereof) of the target application's performance when the first set of network routing configurations has been used. As mentioned above, specific performance metrics may be selected for evaluation based on the application information learned via monitoring of the data traffic. And as mentioned, the specific performance metric(s) that are measured for the application run over different network paths (e.g., each of the first set of network routing configurations defined as a 3-tuple or 5-tuple) may be evaluated alone and against one another. Thus, in aspects, the target application's performance is evaluated by measuring and comparing a performance characteristic of the target application for each network routing configuration in the first set of routing configurations. For example, two distinct routing configurations may be compared to each other by using one or more particular performance metrics. For example, when the performance characteristic or metric being evaluated is bandwidth, a first preferred network routing configuration in the first set may be identified and selected based on the evaluation indicating it has the greatest amount of available bandwidth, relative to the other network routing configurations in the first set. In one example, when the performance characteristic or metric being evaluated is latency, the first preferred network routing configuration in the first set may be identified and selected based on the evaluation indicating it has the lowest latency, relative to the other network routing configurations in the first set. When the performance metric or characteristic being evaluated is jitter, for example, the first preferred network routing configuration in the first set may be identified and selected based on the evaluation indicating it has the lowest value for jitter, relative to the other network routing configurations in the first set.

Accordingly, the selection engine 106 selects 212 a preferred network routing configuration for the application that has an improved performance metric relative to one of the remaining network routing configurations or a plurality of remaining network routing configurations in the first set of routing configurations. In some aspects, the selection engine 106 selects the most optimized of the first set of network routing configurations based on the evaluation that uses a performance metric (or a plurality of performance metrics) that is/are specific to and selected as particularly relevant to evaluating the target application's performance based on the target application's type, as identified in view of its traffic. In one aspect, a single “best” network routing configuration is selected as “preferred.” In other aspects, a plurality of network routing configurations are selected as “preferred,” wherein each of that plurality of network routing configurations is selected for meeting or exceeding a quality threshold or tolerance for the performance metric(s) compared amongst the first set of network routing configurations. The selection engine 106 communicates 214 the preferred network routing configuration (whether one or a plurality) for the target application to the evolution engine 104.

The evolution engine 104, as discussed below, may utilize the preferred network routing configuration as input (e.g., a feedback loop) to initiate additional runs/emulation of the target application for monitoring. For example, from the preferred network routing configuration, the evolution engine 104 may generate 216 a second set of network routing configurations that is at least partially different from the first set. The second set of network routing configurations may be at least partially randomized, while directly taking the preferred network routing configuration into consideration. For example, the preferred network routing configuration may be used as a starting point to generate the second set of network routing configurations because the preferred network routing configuration outperformed the other remaining network routing configurations in the first set, based on the evaluation of the selection engine 106. In this manner, the second set of network routing configurations generated is predicted by the slice-optimized environment to improve or increase the target application's performance when run and/or emulated.

The evolution engine 104 monitors 218 how the target application performs by measuring one or more performance metrics when the target application is run via the device 102 using the second set of routing configurations that is at least partially randomized. The target application may be run using each of the routing configurations and/or combinations thereof in the second set, for example, with randomized variation. The evolution engine 104 communicates 220A performance of the target application when using the second set of routing configurations at the user device, as discussed herein.

The evolution engine 104 optionally communicates 220B performance metrics and/or other monitored information of the target application to the selection engine 106 in more than one instance and/or in an ongoing manner as the target application runs (or is emulated). In one example, the evolution engine 104 may monitor and communicate performance of the target application for each instance that the target application is run (or is emulated) so as to monitor and re-monitor performance of the target application at different instances using the same second set of routing configurations. In another example, the evolution engine 104 may monitor and communicate performance of the target application for each instance that the target application is run (or is emulated) so as to monitor and re-monitor performance of the target application at different instances using variation(s) of the first set of routing configurations.

The selection engine 106 evaluates 222 performance of the target application for each network routing configuration in the second set of routing configurations. In aspects, the target application's performance is evaluated by measuring and comparing a performance characteristic of the target application for each network routing configuration in the second set of routing configurations. For example, two distinct routing configurations may be compared to each other by using one or more particular performance metrics.

The selection engine 106 selects 224 a second preferred network routing configuration for the target application that has an improved performance metric relative to the first preferred network routing configuration and the remaining network routing configurations in the second set of routing configurations evaluated. In other words, the selection engine 106 selects 224 a second preferred network routing configuration for the target application that has an improved performance metric relative to the remaining network routing configurations in the second set of routing configurations, and where applicable, also relative to the first preferred network routing configuration. For example, the selection engine 106 selects a most optimized configuration from the first and the second sets of network routing configurations based on the evaluation that uses a performance metric (or a plurality of performance metrics) that is/are specific to and selected as particularly relevant to evaluating the target application's performance based on the target application's type, as identified in view of its traffic. In one aspect, a single “best” network routing configuration is selected as “preferred,” as discussed above. In other aspects, a plurality of network routing configurations are selected as “preferred,” as discussed above, wherein each of that plurality of network routing configurations is selected for meeting or exceeding a quality threshold or tolerance for the performance metric(s) compared amongst the first and/or second sets of network routing configurations. The selection engine 106 communicates 226 to the evolution engine 104 the second preferred network routing configuration (whether one or a plurality) for the target application that has an improved performance metric relative to the other configurations that are evaluated, and/or that have been previously-selected as a preferred network routing configuration.

From the second preferred network routing configuration, the evolution engine 104 generates 228 a third set of network routing configurations that is at least partially different from the first and second sets of network routing configurations. As such, the evolution engine 104 utilizes the second preferred network routing configuration as input from the selection engine 106 (e.g., a feedback loop) to initiate additional runs/emulation of the target application, such that the sets of network routing configurations improves with each integration or instance of feedback.

The third set of network routing configurations may be at least partially randomized, while directly taking the first and/or second preferred network routing configurations into consideration, in various aspects. For example, the first and/or second preferred network routing configuration may be used as a starting point to generate the third set of network routing configurations because the first and/or second preferred network routing configurations outperformed the other remaining network routing configurations in the first and/or second sets, based on the evaluation of the selection engine 106. In this manner, the third set of network routing configurations generated is predicted by the slice-optimized environment to improve or increase the target application's performance when run and/or emulated.

The evolution engine 104 monitors 230 how the target application performs by measuring one or more performance metrics when the target application is run via the device 102 using the third set of routing configurations that may or may not be at least partially randomized. The target application may be run using each of the routing configurations and/or combinations thereof in the third set, for example, with randomized variation. The evolution engine 104 communicates 232A performance of the target application when using the second set of routing configurations at the user device, as discussed herein.

The evolution engine 104 optionally communicates 232B performance metrics and/or other monitored information of the target application to the selection engine 106 in more than one instance and/or in an ongoing manner as the target application runs (or is emulated). In one example, the evolution engine 104 may monitor and communicate performance of the target application for each instance that the target application is run (or is emulated) so as to monitor and re-monitor performance of the target application at different instances using the same second set of routing configurations. In another example, the evolution engine 104 may monitor and communicate performance of the target application for each instance that the target application is run (or is emulated) so as to monitor and re-monitor performance of the target application at different instances using variation(s) of the third set of routing configurations.

The selection engine 106 evaluates 234 performance of the application for each network routing configuration in the third set of network routing configurations. In aspects, the target application's performance is evaluated by measuring and comparing a performance characteristic of the target application for each network routing configuration in the third set of routing configurations. For example, two distinct routing configurations may be compared to each other by using one or more particular performance metrics.

The selection engine 106 may continue by selecting a third preferred network routing configuration for the application that has an improved performance metric relative to the second preferred network routing configuration and the remaining network routing configurations in the second set of routing configurations evaluated. In other words, the selection engine 106 selects 224 a third preferred network routing configuration for the application that has an improved performance metric relative to the remaining network routing configurations in the third set of routing configurations, and where applicable, also relative to the first and/or second preferred network routing configuration(s). For example, the selection engine 106 selects a most optimized configuration from the first, second, and third sets of network routing configuration based on the evaluation that uses a performance metric (or a plurality of performance metrics) that is/are specific to and selected as particularly relevant to evaluating the target application's performance based on the target application's type, as identified in view of its traffic. In one aspect, a single “best” network routing configuration is selected as “preferred.” In other aspects, a plurality of network routing configurations are selected as “preferred,” wherein each of that plurality of network routing configurations are selected for meeting or exceeding a quality threshold or tolerance for the performance metric(s) compared amongst the first, second, and/or third sets of network routing configurations.

The selection engine 106 communicates 236 the third preferred network routing configuration (whether one or a plurality) for the target application that has an improved performance metric relative to the other configurations that are evaluated, and/or that have been previously-selected as a preferred network routing configuration, as output. Although FIG. 2 illustrates an example using three sets of network routing configurations, it will be understood from this Description that additional sets of network routing configurations may be iteratively generated, monitored, evaluated, and selected within the slice-optimizing environment. For example, from the third preferred network routing configuration that is selected and communicated to the evolution engine 104, a fourth set of network routing configurations may be generated, and so forth. Each set of network routing configurations may be at least partially randomized, or may not be randomized, depending on the quantity of overall cycles or iterations performed to improve the performance metric of the target application. For example, the second set of network routing configurations is generated from the first preferred network routing configuration, the third set of network routing configurations is generated from the second preferred network routing configuration, the fourth set of network routing configurations is generated from the third preferred network routing configuration, and so on, for any quantity of iterative rounds or instances. Accordingly, each generated set of network routing configurations exhibits improved performance metric(s) regarding the target application as being generated from one or more of the preferred network routing configurations having said metric improvements.

The total quantity of iterations may be: a predetermined value; a dynamic value that is specific to or customized for the performance metric (or the plurality of performance metrics) being tested; a dynamic value that is specific to or customized for the type of target application; a dynamic value that is determined when preferred network routing configuration meets and/or exceeds an optimization threshold; a dynamic value that is determined when preferred network routing configuration that is specific to the performance metric (or the plurality of performance metrics) being tested meets and/or exceeds an optimization threshold; or any combination thereof. In one such example, an optimized network routing configuration (whether one, or a plurality, for any quantity of performance metrics) that meets the optimization threshold(s) is/are communicated as output(s) from the user device to a service, a network, another device, or any combination thereof.

As such, the selection engine 106 may select an optimized network routing configuration for the target application when the performance of the target application reaches a threshold or approaches convergence. As used herein, convergence refers to a point when the increase in the performance quality of the target application for the performance metric(s) slows and/or increases by a smaller and smaller amount with each additional round until the increase in performance is negligible, as determined mathematically, as observable to a user of the user device or user of the target application, as observable by hardware and/or software of a network, or any combination thereof. The selection engine 106 may communicate the optimized network routing configuration for the target application to a service, a network, another device, or any combination thereof. In some instances, an optimized network routing configuration for the target application is communicated 236 from the selection engine 106 at the device 102 to a service, a network, another device, or any combination thereof.

Subsequent to an external communication, the optimized network routing configuration for the target application may be stored in a database or repository that is accessible to other users of the target application. Accordingly, the database or repository operates as a crowd-sourced compendium of any quantity of optimized network routing configurations, for any quantity of various applications, for various types of user devices, and/or for various network service levels. In some instances, the slice-optimizing environment may query and retrieve one or more optimized network routing configurations for a target application and/or an application that is similar to the target application (e.g., technologically similar, functionally similar, and/or device-specific).

Having described the system environment 100 and components thereof, it will be understood by those of ordinary skill in the art that system environment 100 is but one example of a suitable system and is not intended to limit the scope of use or functionality of the present invention. Similarly, system environment 100 should not be interpreted as imputing any dependency and/or any requirements with regard to each component and combination(s) of components illustrated in FIGS. 1 and 2. It will be appreciated by those of ordinary skill in the art that the location of components illustrated in FIGS. 1 and 2 is an example, as other methods, hardware, software, components, and devices for establishing a communication links between the components shown in FIGS. 1 and 2, may be utilized in implementations of the present invention. It will be understood to those of ordinary skill in the art that the components may be connected in various manners, hardwired or wireless, and may use intermediary components that have been omitted or not included in FIGS. 1 and 2 for simplicity's sake. As such, the absence of components from FIGS. 1 and 2 should be not be interpreted as limiting the present invention to exclude additional components and combination(s) of components. Moreover, though components are represented in FIGS. 1 and 2 as singular components, it will be appreciated that some embodiments may include a plurality of devices and/or components such that FIGS. 1 and 2 should not be considered as limiting the number of a device or component.

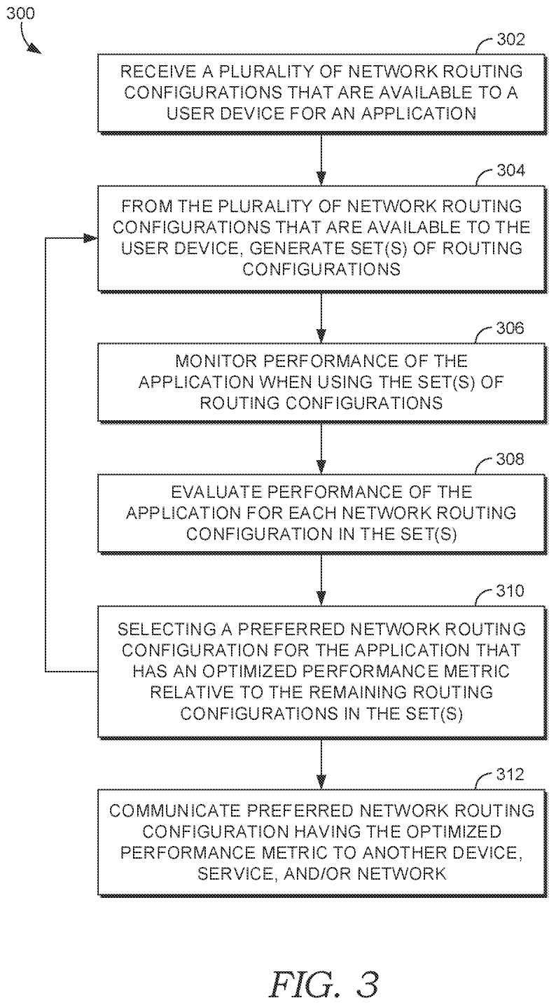

Continuing, FIG. 3 depicts a flowchart of an example method 300. In aspects, the method 300 can be a computer-implemented method. In aspects, one or more non-transitory computer-readable storage media having computer-readable instructions or computer-readable program code portions embodied thereon, for execution via one or more processors, can be used to implement and/or perform the method 300. For example, computer-readable instructions or computer-readable program code portions can specify the performance of the method 300, can specify a sequence of steps of the method 300, and/or can identify particular component(s) of software and/or hardware for performing one or more of the steps of the method 300, in aspects. As discussed below, the method 300 can be performed using software, hardware, component(s), and/or device(s) depicted in the example of FIGS. 1 and/or 2. For example, one or more steps of the method 300 can be performed at a user device, using one or more processors of the user device.

At block 302, a plurality of network routing configurations that are available to a user device for an application are received. For example, the evolution engine 104 of FIGS. 1 and/or 2 receives said plurality of network routing configurations. At block 304, set(s) of network routing configurations are generated from the plurality of network routing configurations that are available to the user device. For example, the evolution engine 104 of FIGS. 1 and/or 2 generates the set of network routing configurations using the plurality of network routing configurations that are received. At block 306, performance of the application when using the set(s) of network routing configurations is monitored. For example, the evolution engine 104 of FIGS. 1 and/or 2 may monitor said performance. At block 308, performance of the application is evaluated for each network routing configuration in the set(s). For example, the selection engine 106 of FIGS. 1 and/or 2 may evaluate the performance of the application for each network routing configuration in the set(s), based on monitoring by the evolution engine 104 of FIGS. 1 and/or 2. At block 310, a preferred network routing configuration for the application is selected that has an optimized performance metric relative to the remaining routing configurations in the set(s). For example, the selection engine 106 of FIGS. 1 and/or 2 selects one or more of the network routing configurations in the set(s) as having an optimized performance metric relative to the remaining routing configurations in the set(s). As shown in FIG. 3, a feedback loop may be formed, such that the preferred network routing configuration that is selected is used as input in the generation of an additional set of network routing configurations. This feedback mechanism, as previously discussed regarding FIG. 2, may be performed iteratively until an optimized preferred network routing configuration is selected. Accordingly, at block 312, the preferred network routing configuration having an optimized performance metric is communicated to another device, service, and/or network.

Turning to FIG. 4, a diagram of an example device 400 that is suitable for use in implementations of aspects herein is provided. The device 400 is but one example of a suitable computing environment and is not intended to suggest any limitation as to the scope of use or functionality of the disclosure, and nor should the device 400 be interpreted as having any dependency or requirement relating to any one or combination of components illustrated.

The implementations of the present disclosure may be described in the general context of computer code or machine-useable instructions, including computer-executable instructions such as program components being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 4, the device 400 includes bus 402 that directly or indirectly couples with the following devices: memory 404, one or more processors 406, one or more presentation components 408, input/output (I/O) ports 410, I/O components 412, and power supply 414. Bus 402 represents what may be one or more buses (such as an address bus, data bus, or combination thereof). Although the devices of FIG. 6 are shown with lines for the sake of clarity, in reality, delineating various components is not so clear, and metaphorically, the lines would more accurately be grey and fuzzy. For example, one may consider a presentation component such as a display device to be one of I/O components 412. Also, processors, such as one or more processors 406, have memory. Distinction is not made between such categories as “workstation,” “server,” “laptop,” “handheld device,” etc., as all are contemplated within the scope of FIG. 6 and refer to “computer” or “computing device.”

The device 400 typically includes a variety of computer-readable media. Computer-readable media can be any available media that can be accessed by the device 400 and includes both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information, such as computer-readable instructions, data structures, program modules, or other data.

Computer storage media includes RAM, ROM, EEPROM, flash memory or other memory technology, CD-ROM, digital versatile disks (DVDs) or other optical disk storage, magnetic cassettes, magnetic tape, and magnetic disk storage or other magnetic storage devices. Computer storage media does not comprise a propagated data signal.

Communication media typically embodies computer-readable instructions, data structures, program modules or other data in a modulated data signal (such as a carrier wave or other transport mechanism), and includes any information delivery media. The term “modulated data signal” indicates a signal that has one or more of its characteristics set or changed in such a manner so as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 404 includes computer storage media in the form of volatile and/or non-volatile memory. Memory 404 may be removable, non-removable, or a combination thereof. Examples of memory include solid-state memory, hard drives, optical disc drives, etc. The device 400 includes one or more processors 406, which read data from various entities such as bus 402, memory 404, or I/O components 412. One or more presentation components 408 present data indications to a person or other device. Examples of one or more presentation components 408 include a display device, speaker, printing component, vibrating component, etc. The I/O ports 410 allow the device 400 to be logically coupled to other devices including I/O components 412, some of which may be built into the device 400. The example I/O components 412 include a microphone, joystick, game pad, satellite dish, scanner, printer, wireless device, etc.

Radio 416 represents a radio that facilitates communication with a wireless telecommunications network. Illustrative wireless telecommunications technologies include CDMA, GPRS, TDMA, GSM, and the like. Radio 416 might additionally or alternatively facilitate other types of wireless communications including Wi-Fi, WiMAX, LTE, or other VoIP communications. As can be appreciated, in various aspects the radio 416 can be configured to support multiple technologies, and/or multiple radios can be utilized to support multiple technologies. A wireless telecommunications network might include an array of devices, which are not shown so as to not obscure more relevant aspects of the disclosure. Components such as a base station, a communications tower, or even access points (as well as other components) can provide wireless connectivity in some aspects.

Regarding FIGS. 1 through 5, it will be understood by those of ordinary skill in the art that the environment(s), system(s), and/or methods(s) depicted are not intended to limit the scope of use or functionality of the present aspects. Similarly, the environment(s), system(s), and/or methods(s) should not be interpreted as imputing any dependency and/or any requirements with regard to each component, each step, and combination(s) of components or step(s) illustrated therein. It will be appreciated by those having ordinary skill in the art that the connections illustrated in the figures are contemplated to potentially include methods, hardware, software, and/or other devices for establishing a communications link between the components, devices, systems, and/or entities, as may be utilized in implementation of the present aspects. As such, the absence of component(s) and/or steps(s) from the figures should not be interpreted as limiting the present aspects to exclude additional component(s) and/or combination(s) of components. Moreover, though devices and components in the figures may be represented as singular devices and/or components, it will be appreciated that some aspects can include a plurality of devices and/or components such that the figures should not be considered as limiting the number of a devices and/or components.

Many different arrangements of the various components depicted, as well as components not shown, are possible without departing from the scope of the claims below. Aspects of our technology have been described with the intent of being illustrative rather than restrictive. Alternative aspects will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A computerized method comprising:
receiving a plurality of network routing configurations that are available to a user device for an application;
from the plurality of network routing configurations that are available to the user device, generating a first set of routing configurations that is at least partially randomized;
monitoring performance of the application when using the first set of routing configurations that is at least partially randomized at the user device;
evaluating performance of the application for each network routing configuration in the first set of routing configurations; and
selecting a first preferred network routing configuration for the application that has an improved performance metric relative to a remaining network routing configuration in the first set of routing configurations evaluated.

2. The method of claim 1 further comprising:
from the preferred network routing configuration, generating a second set of network routing configurations that is at least partially different from the first set;
monitoring performance of the application when using the second set of routing configurations at the user device;
evaluating performance of the application for each network routing configuration in the second set of routing configurations; and
selecting a second preferred network routing configuration for the application that has an improved performance metric relative to the first preferred network routing configuration and the remaining network routing configurations in the second set of routing configurations evaluated.

3. The method of claim 2 further comprising:
from the second preferred network routing configuration, generating a third set of network routing configurations that is at least partially different from the first and second sets;
monitoring performance of the application when using the third set of network routing configurations at the user device;
evaluating performance of the application for each network routing configuration in the third set of network routing configurations; and
selecting a third preferred network routing configuration for the application that has an improved performance metric relative to the second preferred network routing configuration and the remaining network routing configurations in the second set of routing configurations evaluated.

4. The method of claim 3 further comprising, from the third preferred network routing configuration, generating a fourth set of network routing configurations.

5. The method of claim 4 wherein the second set of network routing configurations is generated from the first preferred network routing configuration, wherein the third set of network routing configurations is generated from the second preferred network routing configuration, and wherein the fourth set of network routing configurations is generated from the third preferred network routing configuration.

6. The method of claim 1, wherein additional sets of network routing configurations are iteratively generated, monitored, evaluated, and selected until an optimization threshold is met, and wherein the media further comprises communicating an optimized network routing configuration that meets the optimization threshold from the user device to a service, a network, another device, or any combination thereof.

7. The method of claim 6, communicating the optimized network routing configuration for the application from the user device to a service, a network, another device, or any combination thereof.

8. The method of claim 1, further comprising identifying the application based on one or more traffic characteristics comprising: a protocol type, a port identifier, an inter-packet arrival time, a packet size, a throughput value, or any combination thereof.

9. The method of claim 1, wherein evaluating performance of the application for each network routing configuration in the first set of routing configurations comprises measuring and comparing a performance characteristic of the application for each network routing configuration in the first set of routing configurations.

10. The method of claim 9, when the performance characteristic is bandwidth, the first preferred network routing configuration is evaluated as having a greatest amount of available bandwidth, wherein when the performance characteristic is latency, the first preferred network routing configuration is evaluated as having a lowest latency, and wherein when the performance characteristic is jitter, the first preferred network routing configuration is evaluated as having a lowest jitter value.

11. The method of claim 9, further comprising selecting the performance characteristic that is a specific indicator for measuring performance of the application at the user device.

12. One or more non-transitory computer-readable media storing instructions that when executed via one or more processors perform a computerized method, the instructions stored on the non-transitory computer-readable media comprising:
receiving a plurality of network routing configurations that are available to a user device for an application;
from the plurality of network routing configurations that are available to the user device, generating a first set of routing configurations that is at least partially randomized;
monitoring performance of the application when using the first set of routing configurations that is at least partially randomized at the user device;
evaluating performance of the application for each network routing configuration in the first set of routing configurations; and
selecting a preferred network routing configuration for the application that has an improved performance metric relative to a remaining network routing configuration in the first set of routing configurations evaluated.

13. The media of claim 12, wherein additional sets of network routing configurations are iteratively generated, monitored, evaluated, and selected until an optimization threshold is met.

14. The media of claim 12, further comprising communicating an optimized network routing configuration that meets the optimization threshold from the user device to a service, a network, another device, or any combination thereof.

15. The media of claim 12, further comprising identifying the application based on one or more traffic characteristics comprising: a protocol type, a port identifier, an inter-packet arrival time, a packet size, a throughput value, or any combination thereof.

16. The media of claim 14, further comprising selecting, based on the one or more traffic characteristics, the performance characteristic that is an indicator of performance of the application identified.

17. A system comprising:
a computer application that, via one or more processors executing computer-readable instructions stored in a memory of a device:
receives a plurality of network routing configurations that are available to a user device for an application;
from the plurality of network routing configurations that are available to the user device, generates a first set of routing configurations that is at least partially randomized;
monitors performance of the application when using the first set of routing configurations that is at least partially randomized at the user device;
evaluates performance of the application for each network routing configuration in the first set of routing configurations; and
selects a preferred network routing configuration for the application that has an improved performance metric relative to a remaining network routing configuration in the first set of routing configurations evaluated.

18. The system of claim 17, where the plurality of network routing configurations that are available to the user device for the application comprise a 3-tuple or a 5-tuple.

19. The system of claim 17, wherein the 3-tuple specifies a source Internet Protocol (IP), a destination IP, and an IP protocol, and wherein the 5-tuple specifies a source IP, a destination IP, an IP protocol, a source port, and a destination port.

20. The system of claim 17, wherein additional sets of network routing configurations are iteratively generated, monitored, evaluated, and selected until an optimization threshold is met, and wherein an optimized network routing configuration that meets the optimization threshold is communicated from the application to a service, a network, another device, or any combination thereof.
